(19) United States
(12) Patent Application Publication
(10) Pub. No.: US 2019/0236576 A1
(43) Pub. Date: Aug. 1, 2019

(54) SHOP AND DROP CHECKOUT

(71) Applicant: NCR Corporation, Duluth, GA (US)

(72) Inventors: Michael Grant Gibson, Buford, GA (US); John William Crawford, Sugar Hill, GA (US)

(21) Appl. No.: 15/885,470

(22) Filed: Jan. 31, 2018

(51) Int. Cl. G06Q 20/20; G06K 7/14

(52) U.S. Cl. CPC G06Q 20/208; G06Q 30/0226; G06K 7/1413; G06Q 20/209

(57) ABSTRACT

Disclosed herein are transaction completions methods and systems. The systems and methods may include receiving, at a computing device comprising a processor, shopper information associated with a shopper; printing a team member receipt and a customer receipt. The team member receipt and the customer receipt each may include a matching code. The systems and methods may further include receiving product information for a plurality of products the shopper wishes to purchase and printing a transaction receipt listing the plurality of products the shopper purchased. The team member receipt may be matched with the customer receipt via the matching code.

### SUMMARY

Systems and methods may include receiving, at a computing device comprising a processor, shopper information associated with a shopper; printing a team member receipt and a customer receipt. The team member receipt and the customer receipt each may include a matching code. The systems and methods may further include receiving product information for a plurality of products the shopper wishes to purchase and printing a transaction receipt listing the plurality of products the shopper purchased. The team member receipt may be matched with the customer receipt via the matching code.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an example schematic consistent with this disclosure.

FIG. 2 shows an example schematic of a computing device consistent with this disclosure.

FIG. 3 shows an example method consistent with this disclosure.

Corresponding reference characters indicate corresponding parts throughout the several views. The exemplifications set out herein illustrate exemplary embodiments of the invention, and such exemplifications are not to be construed as limiting the scope of the invention any manner.

### DETAIL ED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit this disclosure. Instead, the proper scope of any invention disclosed herein is defined by the appended claims.

Currently, when customer shop at busy time, they may be forced to wait in long lines when checking out at stores. As disclosed herein, customers may be able to shop and then allow store personnel to process items in their cart while the customer retrieves their cars. As disclosed herein, customers may place items into their shopping carts and then leave the cart and its contents with an employee of the store. The employee may print a customer receipt and a team member receipt. The customer receipt may be given to the customer. The customer may then go and retrieve his or her vehicle.

While the customer is retrieving his or her vehicle, the employee (sometimes referred to as a clerk, sales associate, or team member) may ring up or otherwise process the items in the customer's shopping cart. After ringing up the items in the customer's shopping cart, the employee may take the items outside of the store to a designated pickup area.

The customer may be waiting in the designated pickup area with his or her vehicle. Upon the employee arriving with the items, the employee may confirm that the customer is the correct customer and give the customer the items. The employee may confirm the customer's identity by comparing the customer receipt with the team member receipt. The confirmation may be made because the customer receipt and the team member receipt may have a matching code. For instance, the customer receipt and the team member receipt may have an alphanumeric code, a scannable bar code, etc. that may allow the employee to verify the customer.

When the employee verifies the customer, the employee can give the customer his or her items and a transaction receipt. The transaction receipt may show the items purchased, the cost of each item, the total cost for the purchase, and that the items were actually paid for. The employee may complete the transaction because when the customer left the cart of items with the employee, the customer provided customer information to complete the transaction. The customer information may include payment information (e.g., credit or debit card information), age verification, loyalty rewards program information, etc.

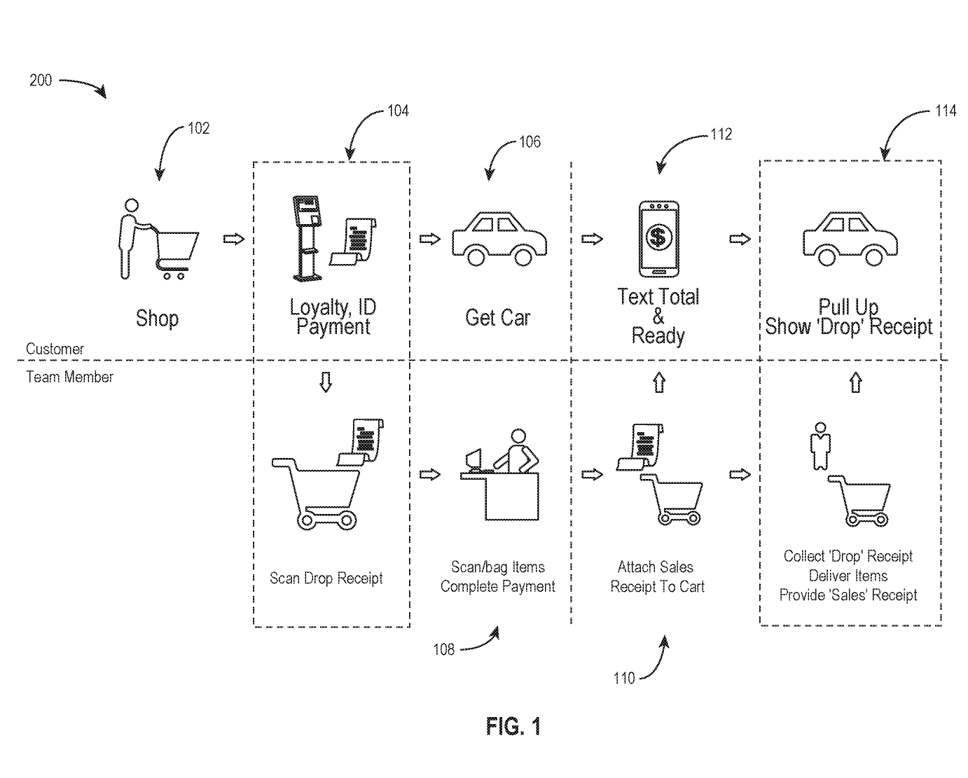

FIG. 1 shows an example schematic 100 for completing a transaction consistent with this disclosure. As shown in FIG. 1, when completing a transaction, a customer may walk shop at a store as indicated by reference numeral 102. The customer may pick various items and place them in a cart.

After the customer has completed his or her shopping, he or she may approach a scan and drop location as indicated by reference numeral 104. At the scan and drop location, the customer may also provide customer information to facilitate the transaction. For example, while at the scan and drop location, the customer may provide payment information such as a credit or debit card information. In addition, the customer may provide loyalty rewards program information. The payment information and the loyalty rewards program information may be provided by the customer provide one or more cards (i.e., a credit card and a rewards card). The customer may also provide any personal identification number (PIN) or other security information that may be needed to complete the transaction.

The payment and loyalty rewards program information may also be provided by an app on the customer's mobile device, such as a phone. For instance, when the customer approaches the scan and drop location the customer or an employee of the store may scan a barcode generated by an app on the customer's phones. The barcode may include information to identify the customer and payment information. In addition, the barcode may he a pointer that points to a record in a database where the customer's loyalty and payment information can be retrieved.

While at the scan and drop location, an employee may also validate the age of the customer. For example, at the scan and drop location the customer may enter his or her information, including his or her age, into a terminal in anticipation of buying age restricted items such as alcohol or tobacco products. Once the information is entered, the employee may ask the customer to see his or her identification to verify the customer's age. The verification of the customer's age may only be accomplished by the employee. The customer may provide the information, but the employee must verify that the customer is the age claimed.

Once the customer has provided his or her information, a customer receipt and a team member receipt may be printed. The customer receipt and the team member receipt may also be referred to a shop and drop receipts. The customer receipt and the team member receipt may each include a matching code. The matching code may be used later to match up the customer with his or her items after payment as described herein.

The customer may go and retrieve his or her car as indicated by reference numeral 106. While the customer is retrieving his or her car, the employee may ring up the customer's items as indicated by reference numeral 108. By processing the customer's items while the customer retrieves his or her vehicle may allow the customer to save time within the store. In addition, congestion within the store may also be reduced by having the employee process the customer's items while the customer retrieves his or her vehicle.

Once the employee is finished ring up the customer's items, the employee may print a transaction receipt, sometimes referred to as a sales receipt. The transaction receipt may be attached to the customer's cart as shown by reference numeral 110. The transaction receipt may include a listing of the items purchased, the cost of each item, any discounts applied to the items purchased, and a confirmation that the items have been paid for. In addition, the transaction receipt may include a listing of items that were in the customer's cart, but were not sold. For instance, an age restricted item may have been in the cart, but the customer's age was not verified. Thus, the age restricted item was not sold, but may be listed on the transaction receipt so that the customer knows why it is missing from his or her purchases.

In addition to printing the transaction receipt, the employee may also send a text message or other notification to the customer as indicated by reference numeral 112. The notification may include a message advising the customer that his or her transaction is complete and as well as provide the customer with a total for the transaction. In addition, the notification may advise the customer as to where his or her purchases can be picked up. The notification may also include an electronic version of the transaction receipt.

As shown by reference numeral 114, the customer may bring his or her automobile to a designated pickup spot. While at the designated pickup spot, the customer may show his or her drop receipt and the employee may verify that the matching code on the drop receipt matches the matching code on the team member receipt. Once the drop receipt is verified by the team member, the customer may load his or her purchases into his or her vehicle.

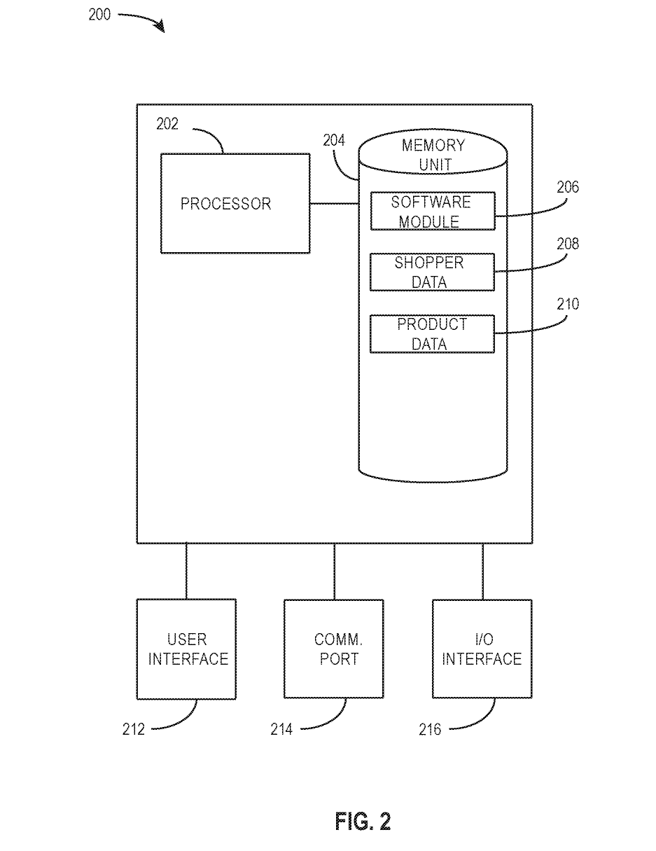

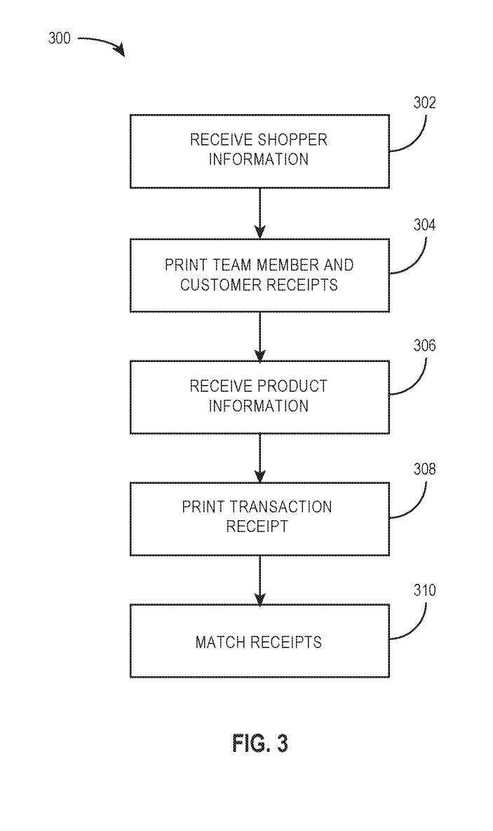

FIG. 2 shows an example schematic of the computing device 200. As shown in FIG. 2, the computing device 200 may include a processing unit 202 and a memory 204. The memory 204 may include a software module 206, shopper data 208, and product data 210. While executing on processing unit 202, the software module 204 may perform processes for processing a transaction, including, for example, one or more stages included in a method 300 described below with respect to FIG. 3.

As indicated above, the shopper data may include loyalty reward program information such as a user identifier (i.e., an identification number), shopping preferences, brand preferences, etc. The shopper data may also include payment information such as a credit or debit card number, a checking account routing number and account number.

The product data 210 may include prices, skew numbers, discounts, etc. for products within a store. The product data 210 may also include sale data and discount data for products. The product data may also include an identifier that identifies items such as alcohol or tobacco that is age restricted.

The computing device 200 may also include a user interface 212. The user interface 212 can include any number of devices that allow a user to interface with the computing device 200. Non-limiting examples of the user interface 212 include a keypad, a microphone, a display (touchscreen or otherwise), etc. The user interface 212 may allow the customer to enter his or her shopper data as disclosed herein. In addition, the user interface 212 may allow the employee to enter information such as age verification of the shopper.

The computing device 200 may also include a communications port 214. The communications port 214 may allow the computing device 200 to communicate with various information sources, such as, but not limited to, the payment processing systems, remote computing devices. etc. Non-limiting examples of the communications port 214 include, Ethernet cards (wireless or wired), Bluetooth® transmitters and receivers, near-field communications modules, etc. As disclosed herein, the communications port 214 may allow the computing device 200 to transmit the shopper's payment information to a remote payment system. In addition, the communications port 214 may allow the computing device 200 to transmit and receive information to and from a central server. For example, the computing device 200 may be a point of sale device and during the transaction, the computing device 200 may retrieve the product information from the central serve and may transmit purchase totals and other financial data to the server for storage or other processing.

The computing device 200 may also include an input/output (I/O) device 216. The I/O device 216 may allow the computing device 200 to receive and output information. Non-limiting examples of the I/O device 220 include, a camera (still or video), a printer, a scanner, etc. For example, the I/O device 216 may include a scanner that can be used to scan barcodes on products, a shopper's loyalty rewards card, credit card, etc. The I/O device 216 may also include a printer that can be used to print the customer's drop receipt, the team member receipt, and the transaction receipt.

As indicated herein, the computing device 200 may be a point of sale terminal. The computing device 200 may also be a server located in a back room or offsite from a store. Thus, the I/O device 216 and the communications port 214 may allow scanners, terminals, etc. in a store to communication with the computing device 200. The computing device 200 may be implemented using a personal computer, a network computer, a mainframe, a handheld device, a personal digital assistant, a smartphone, or any other similar microcomputer-based workstation.

FIG. 3 shows an example method 300 for completing a transaction. The method 300 may begin at stage 302, where a computing device, such as the computing device 200, may receive shopper information associated with a shopper. As disclosed herein, the shopper may enter his or her information via a keypad, scanner, or other I/O device, such as I/O device 216 or user interface 212.

From stage 302 the method 300 may advance to stage 304 where the team member receipt and the customer, or drop, receipt are printed. The customer receipt may also be transmitted to the customer in electronic form as well. For example, as disclosed herein, a computing device, such as the computing device 200, may transmit team member receipt information and customer receipt information to a printer for printing. The team member receipt information and the customer receipt information may include the matching code and other identifying information used to match the purchased items to the customer.

From stage 304 the method 300 may advance to stage 306 where the computing device may receive product information for a plurality of products the customer wishes to purchase. For example, the computing device may receive skew information, which may be used to retrieve price or other information about the products. Stated another way, at stage 306, the employee rings up the customer's purchases.

From stage 306 the method 300 may advance to stage 308 where a transaction, or sales, receipt is printed and/or transmitted electronically. For example, as disclosed herein, the computing device may transmit transactions receipt information to a printer for printing. The transaction receipt information may include a listing of the items purchased as well as the cost of the items and an acknowledgement that the items have been paid for.

From stage 308 the method 300 may advance to stage 310 where the team member receipt may be matched up with the customer receipt. As disclosed herein, the team member receipt and the customer receipt may be matched outside the store at the pickup area after the customer has retrieved his or her car. The team member receipt and the customer receipt may be matched by scanning a barcode, QR code or other information that is readable by a scanner.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

### EXAMPLES

Example 1 is a method for completing a transaction, the method comprising: receiving, at a computing device comprising a processor, shopper information associated with a shopper; printing, via a printer electrically coupled to the computing device, a team member receipt and a customer receipt, the team member receipt and the customer receipt each including a matching code; receiving, at the computing device, product information for a plurality of products the shopper wishes to purchase; printing, via the printer, a transaction receipt listing the plurality of products the shopper purchased; and matching the team member receipt with the customer receipt via the matching code.

In Example 2, the subject matter of Example 1 optionally includes wherein the product information is received via a scanner operated by a team member.

In Example 3, the subject matter of any one or more of Examples 1-2 optionally include wherein receiving the shopper information includes receiving payment associated with the shopper.

In Example 4, the subject matter of any one or more of Examples 1-3 optionally include wherein receiving the shopper information includes receiving loyalty reward information associated with the shopper.

In Example 5, the subject matter of any one or more of Examples 1-4 optionally include wherein receiving the shopper information includes: receiving age information associated with the shopper; and verifying the age information associate with the shopper.

In Example 6, the subject matter of Example 5 optionally includes wherein printing the transaction receipt includes excluding age restricted items when the age information associated with the shopper cannot be verified.

In Example 7, the subject matter of any one or more of Examples 1-6 optionally include wherein matching the team member receipt with the customer receipt occurs outside a store.

In Example 8, the subject matter of any one or more of Examples 1-7 optionally include wherein printing the customer receipt and the team member receipt includes printing an order number and payment information on both the customer receipt and the team member receipt.

Example 9 is a system for completing a transaction, the system comprising: a printer; a processor in electrical communication with the printer; and a memory storing instructions that, when executed by the processor, cause the processor to: transmit, to the printer, a team member receipt information and a customer receipt information, the team member receipt information and the customer receipt information each including a matching code, receive product information for a plurality of products a customer wishes to purchase, transmit, to the printer, transaction receipt information including the product information for the plurality of products the shopper purchased, and match the team member receipt with the customer receipt via the matching code.

In Example 10, the subject matter of Example 9 optionally includes instructions that, when executed by the processor, cause the processor to receive the product information from a scanner in electrical communication with the processor.

In Example 11, the subject matter of any one or more of Examples 9-10 optionally include wherein receiving the shopper information further comprises instructions that, when executed by the processor, cause the processor to receive payment associated with the shopper.

In Example 12, the subject matter of any one or more of Examples 9-11 optionally include wherein receiving the shopper information further comprises instructions that, when executed by the processor, cause the processor to receive loyalty reward information associated with the shopper.

In Example 13, the subject matter of any one or more of Examples 9-12 optionally include wherein receiving the shopper information further comprises instructions that, when executed by the processor, cause the processor to: receive age information associated with the shopper; and verify the age information associate with the shopper.

In Example 14, the subject matter of Example 13 optionally includes wherein transmitting the transaction receipt information to the printer further comprises instructions that, when executed by the processor, cause the processor to exclude product information for age restricted items when the age information associated with the shopper cannot be verified.

In Example 15, the subject matter of any one or more of Examples 9-14 optionally include wherein matching the team member receipt with the customer receipt further comprises instructions that, when executed by the processor, cause the processor to verify that the matching code on a customer receipt is identical to the matching information on a team member receipt.

In Example 16, the subject matter of any one or more of Examples 9-15 optionally include wherein transmitting the customer receipt information and the team member receipt information further comprises instructions that, when executed by the processor, cause the processor to transmit an order number and payment information for printing on both the customer receipt and the team member receipt.

Example 17 is a non-transitory computer-readable medium storing instruction that, when executed by a processor, cause the processor to: transmit, to a printer, a team member receipt information and a customer receipt information, the team member receipt information and the customer receipt information each including a matching code; receive product information for a plurality of products a customer wishes to purchase; transmit, to the printer, transaction receipt information including the product information for the plurality of products the shopper purchased; and match the team member receipt with the customer receipt via the matching code.

In Example 18, the subject matter of Example 17 optionally includes instructions that, when executed by the processor, cause the processor to receive the product information from a scanner in electrical communication with the processor.

In Example 19, the subject matter of any one or more of Examples 17-18 optionally include wherein receiving the shopper information further comprises instructions that, when executed by the processor, cause the processor to receive payment associated with the shopper.

In Example 20, the subject matter of any one or more of Examples 17-19 optionally include wherein receiving the shopper information further comprises instructions that, when executed by the processor, cause the processor to receive loyalty reward information associated with the shopper.

In Example 21, the subject matter of any one or more of Examples 17-20 optionally include wherein receiving the shopper information further comprises instructions that, when executed by the processor, cause the processor to: receive age information associated with the shopper; and verify the age information associate with the shopper.

In Example 22, the subject matter of Example 21 optionally includes wherein transmitting the transaction receipt information to the printer further comprises instructions that, when executed by the processor, cause the processor to exclude product information for age restricted items when the age information associated with the shopper cannot be verified.

In Example 23, the subject matter of any one or more of Examples 17-22 optionally include wherein matching the team member receipt with the customer receipt further comprises instructions that, when executed by the processor, cause the processor to verify that the matching code on a customer receipt is identical to the matching information on a team member receipt.

In Example 24, the subject matter of any one or more of Examples 17-23 optionally include wherein transmitting the customer receipt information and the team member receipt information further comprises instructions that, when executed by the processor, cause the processor to transmit an order number and payment information for printing on both the customer receipt and the team member receipt.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

Claimed is:

1. A method for completing a transaction, the method comprising:
receiving, at a computing device comprising a processor, shopper information associated with a shopper;
printing, via a printer electrically coupled to the computing device, a team member receipt and a customer receipt, the team member receipt and the customer receipt each including a matching code;
receiving, at the computing device, product information for a plurality of products the shopper wishes to purchase;
printing, via the printer, a transaction receipt g the plurality of products the shopper purchased; and
matching the team member receipt with the customer receipt via the matching code.

2. The method of claim 1, wherein the product information is received via a scanner operated by a team member.

3. The method of claim 1, wherein receiving the shopper information includes receiving payment associated with the shopper.

4. The method of claim 1, wherein receiving the shopper information includes receiving loyalty reward information associated with the shopper.

5. The method of claim 1, wherein receiving the shopper information includes:
receiving age information associated with the shopper; and
verifying the age information associate with the shopper.

6. The method of claim 5, wherein printing the transaction receipt includes excluding age restricted items when the age information associated with the shopper cannot be verified.

7. The method of claim 1, wherein matching the team member receipt with the customer receipt occurs outside a store.

8. The method of claim 1, wherein printing the customer receipt and the team member receipt includes printing an order number and payment information on both the customer receipt and the team member receipt.

9. A system or completing a transaction, the system comprising:
a printer;
a processor in electrical communication with the printer; and
a memory storing instructions that, when executed by the processor, cause the processor to:
transmit, to the printer, a team member receipt information and a customer receipt information, the team member receipt information and the customer receipt information each including a matching code,
receive product information for a plurality of products a customer wishes to purchase,
transmit, to the printer, transaction receipt information including the product information for the plurality of products the shopper purchased, and match the team member receipt with the customer receipt via the matching code.

10. The system of claim 9, further comprising instructions that, when executed by the processor, cause the processor to receive the product information from a scanner in electrical communication with the processor.

11. The system of claim 9, wherein receiving the shopper information further comprises instructions that, when executed by the processor, cause the processor to receive payment associated with the shopper.

12. The system of claim 9, wherein receiving the shopper information further comprises instructions that, when executed by the processor, cause the processor to receive loyalty reward information associated with the shopper.

13. The system of claim 9, wherein receiving the shopper information further comprises instructions that, when executed by the processor, cause the processor to:
receive age information associated with the shopper; and
verify the age information associate with the shopper.

14. The system of claim 13, wherein transmitting the transaction receipt information to the printer further comprises instructions that, when executed by the processor, cause the processor to exclude product information for age restricted items when the age information associated with the shopper cannot be verified.

15. The system of claim 9, wherein matching the team member receipt with the customer receipt further comprises instructions that, when executed by the processor, cause the processor to verify that the matching code on a customer receipt is identical to the matching information on a team member receipt.

16. The system of claim 9, wherein transmitting the customer receipt information and the team member receipt information further comprises instructions that, when executed by the processor, cause the processor to transmit an order number and payment information for printing on both the customer receipt and the team member receipt.

17. A non-transitory computer-readable medium storing instruction that, when executed by a processor, cause the processor to:
transmit, to a printer, a team member receipt information and a customer receipt information, the team member receipt information and the customer receipt information each including matching code;
receive product information for a plurality of products a customer wishes to purchase;
transmit, to the printer, transaction receipt information including the product information for the plurality of products the shopper purchased; and
match the team member receipt with the customer receipt via the matching code.

18. The non-transitory computer-readable medium of claim 17, wherein receiving the product information further comprises instructions that, when executed by the processor, cause the processor to receive the product information from a scanner in electrical communication with the processor.

19. The non-transitory computer-readable medium of claim 17, wherein receiving the shopper information further comprises instructions that, when executed by the processor, cause the processor to:
receive payment associated with the shopper and
receive loyalty reward information associated with the shopper.

20. The non-transitory computer-readable medium of claim 17, further comprising instructions that, when executed by the processor, cause the processor to:
receive age information associated with the shopper;
verify the age information associate with the shopper; and
exclude product information for age restricted items from being transmitted with the product information when the age information associated with the shopper cannot be verified.
